(19) United States
(12) Patent Application Publication
(10) Pub. No.: US 2007/0164647 A1
(43) Pub. Date: Jul. 19, 2007

(54) Spacer and electron emission display having the spacer

(76) Inventors: Sung-Hwan Jin, Suwon-si (KR); Cheol-Hyeon Chang, Suwon-si (KR)

Correspondence Address: Robert E. Bushnell;Suite 300, 1522 K Street, N.W., Washington, DC, 20005-1202, US

(21) Appl. No.: 11/585,174

(22) Filed: Oct. 24, 2006

(30) Foreign Application Priority Data
Oct. 25, 2005 (KR) 10-2005-0100667

(51) Int. Cl. H01J 19/42; H01J 1/88; H01K 1/18

(52) U.S. Cl. 313/292

(57) ABSTRACT

A spacer which can effectively discharge secondary electrons and an electron emission display having the spacer include: a main body disposed between first and second substrates which have first and second electrode layers, respectively; and a coating layer formed on a side surface of the main body. The coating layer has a first portion contacting one of the first and second electrode layers and a second portion formed on a central portion of the side surface of the main body. A thickness of the first portion is greater than that of the second portion.

### CLAIM OF PRIORITY

This application makes reference to, incorporates the same herein, and claims all benefits accruing under 35 U.S.C. §119 from an application for SPACER AND ELECTRON EMISSION DISPLAY HAVING THE SPACER earlier filed in the Korean Intellectual Property Office on the 25 of Oct. 2005 and there duly assigned Ser. No. 10-2005-0100667.

### BACKGROUND OF THE INVENTION

1. Technical Field

The present invention relates to a spacer disposed between two substrates forming a vacuum envelope for maintaining a gap between the substrates and an electron emission display having the spacer.

2. Related Art

Generally, electron emission elements arrayed on electron emission devices are classified into those using hot cathodes as an electron emission source, and those using cold cathodes as the electron emission source.

There are several types of cold cathode electron emission elements, including Field Emitter Array (FEA) elements, Surface Conduction Emitter (SCE) elements, Metal-Insulator-Metal (MIM) elements, and Metal-Insulator-Semiconductor (MIS) elements.

The MIM element includes first and second metal layers and an insulation layer interposed between the first and second metal layers. The MIS element includes a metal layer, a semiconductor layer, and an insulation layer interposed between the metal layer and the semiconductor layer. In the MIM element, when a voltage is applied between the first and second metal layers, electrons generated from the first metal layer reach the second metal layer through the insulation layer by a tunneling phenomenon. Among the electrons reaching the second metal layer, some electrons, each having energy higher than a work function of the second metal layer, are emitted from the second metal layer. In the MIS element, when a voltage is applied between the metal layer and the semiconductor layer, electrons generated from the semiconductor layer reach the metal layer through the insulation layer by a tunneling phenomenon. Among the electrons reaching the metal layer, some electrons, each having energy higher than a work function of the metal layer, are emitted from the metal layer.

The SCE element includes first and second electrodes facing each other and a conductive layer disposed between the first and second electrodes. Fine cracks are formed on the conductive layer to form the electron emission regions. When a voltage is applied to the first and second electrodes so as to allow a current to flow along a surface of the conductive layer, electrons are emitted from the electron emission regions.

The FEA elements use a theory in which, when a material having a relatively low work function or a relatively large aspect ratio is used as the electron source, electrons are effectively emitted by an electric field under a vacuum atmosphere. Recently, the electron emission regions have been formed of a material having a relatively low work function or a relatively large aspect ratio, such as a molybdenum-based material, a silicon-based material, and a carbon-based material such as carbon nanotubes, graphite, and diamond-like carbon, so that electrons can be effectively emitted when an electric field is applied thereto under a vacuum atmosphere. When the electron emission regions are formed of the molybdenum-base material or the silicon-based material, they are formed in a pointed tip structure.

The electron emission elements are arrayed on a substrate to form an electron emission device. The electron emission device is combined with another substrate on which a light emission unit, including phosphor layers and an anode electrode, is disposed, thereby providing an electron emission display.

The electron emission device includes electron emission regions and a plurality of driving electrodes functioning as scan and data electrodes. By means of the operation of the electron emission regions and the driving electrodes, the on/off operation of each pixel and an amount of electron emission are controlled. The electron emission display excites phosphor layers using the electrons emitted from the electron emission regions so as to display a predetermined image.

In addition, a plurality of spacers are disposed in the vacuum envelope to prevent the substrates from being damaged or broken by a pressure difference between the interior and exterior of the vacuum envelope.

The spacers are exposed to the internal space of the vacuum envelope in which electrons emitted from the electron emission regions move. Therefore, the spacers are positively or negatively charged by the electrons colliding therewith. The charged spacers may distort the electron beam path by attracting or repulsing the electrons, thereby deteriorating the color reproduction and luminance of the electron emission display.

In order to prevent the change in the electron beam path, the spacers may be coated with an insulation material or may be connected to the electrodes so as to discharge the electric charge accumulated on the space to the exterior. However, since the coating layer has a thickness less than 1 μm, it doe not effectively contact the electrodes.

### SUMMARY OF THE INVENTION

The present invention provides a spacer which is maximized in its electric conduction efficiency by varying the thickness of a coating layer formed on a side surface of the spacer, and an electron emission display having the spacer.

In an exemplary embodiment of the present invention, a spacer includes: a main body disposed between first and second substrates which have first and second electrode layers, respectively; and a coating layer formed on a side surface of the main body; wherein the coating layer has a first portion contacting one of the first and second electrode layers and a second portion formed on a central portion of the side surface of the main body, a thickness of the first portion being greater than that of the second portion.

The coating layer may include an upper coating layer contacting the second electrode layer and a lower coating layer contacting the first electrode layer, and a central layer integrally connecting the upper coating layer to the lower coating layer; and the thickness of at least one of the upper and lower coating layers may increase gradually from a connecting portion with the central coating layer to an end of the main body.

In another exemplary embodiment, an electron emission display includes: first and second substrates facing each other to form a vacuum envelope; an electron emission unit provided on the first substrate; a light emission unit provided on the second substrate; and a spacer disposed between the electron emission unit and the light emission unit. The spacer includes: a main body disposed between first and second substrates which have first and second electrode layers, respectively; and a coating layer formed on a side surface of the main body; wherein the coating layer has a first portion contacting one of the electron and light emission units and a second portion formed on a central portion of the side surface of the main body, a thickness of the first portion being greater than that of the second portion.

The coating layer may include an upper coating layer contacting the light emission unit and a lower coating layer contacting the electron emission unit, and a central layer integrally connecting the upper coating layer to the lower coating layer. The thickness of at least one of the upper and lower coating layers may increase gradually from a connecting portion with the central coating layer to an end of the main body.

The thickness of the main body may be uniform while at least one of the upper and lower coating layers varies.

The thickness increase rate of at least one of the upper and lower coating layers may be constant.

Alternatively, the thickness increase rate of at least one of the upper and lower coating layers may increase.

Alternatively, the main body may have a first portion corresponding to at least one of the upper and lower coating layers, and the thickness of the first portion of the main body may be gradually reduced toward an end thereof. In this case, the thickness of the spacer may be uniform.

The thickness reduction rate of the first portion of the main body may be constant.

The thickness reduction rate of the first portion of the main body may increase.

The upper coating layer, the lower coating layer, and the central coating layer satisfy the following condition:
T₂/T₁<5
where T₁ is the thickness of the central coating layer, and T₂ is the maximum thickness of one of the upper and lower coating layers.

The coating layer may include a material selected from the group consisting of chromium oxide (Cr₂O₃), titanium nitride (TiN), zirconium oxide (ZrO₂), diamond-like carbon, and a combination thereof.

The electron emission unit may include: cathode and gate electrodes formed on the first substrate and insulated from each other; an electron emission region connected to the cathode electrode; and a focusing electrode formed on and insulated from the cathode and gate electrodes.

The spacer may be disposed on the focusing electrode.

The electron emission region may include a material selected from the group consisting of carbon nanotubes, graphite, graphite nanofibers, diamonds, diamond-like carbon, C₆₀, silicon nanowires, or a combination thereof.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components,

FIG. 1A is a partly broken, exploded perspective view of an electron emission display according to a first embodiment of the present invention;

FIG. 1B is an enlarged view of a portion A of FIG. 1A;

FIG. 2 is a partly broken, sectional view of the electron emission display of FIG. 1A;

FIG. 3 is an enlarged sectional view of a spacer, focusing electrode and second insulation layer of the electron emission display of FIG. 1A;

FIG. 4 is an enlarged sectional view of a spacer, focusing electrode and second insulation layer of an electron emission display according to a second embodiment of the present invention;

FIG. 5 is an enlarged sectional view of a spacer, focusing electrode and second insulation layer of an electron emission display according to a third embodiment of the present invention; and

FIG. 6 is an enlarged sectional view of a spacer, focusing electrode and second insulation layer of an electron emission display according to a fourth embodiment of the present invention.

### DETAILED DESCRIPTION OF INVENTION

The present invention will now be described more fully with reference to the accompanying drawings, in which exemplary embodiments of the invention are shown. The invention may, however, be embodied in many different forms and should not be construed as being limited to the embodiments set forth herein; rather these embodiments are provided so that this disclosure will be thorough and complete, and will fully convey the concept of the invention to those skilled in the art. Wherever possible, the same reference numbers will be used throughout the drawings to refer to the same or like parts.

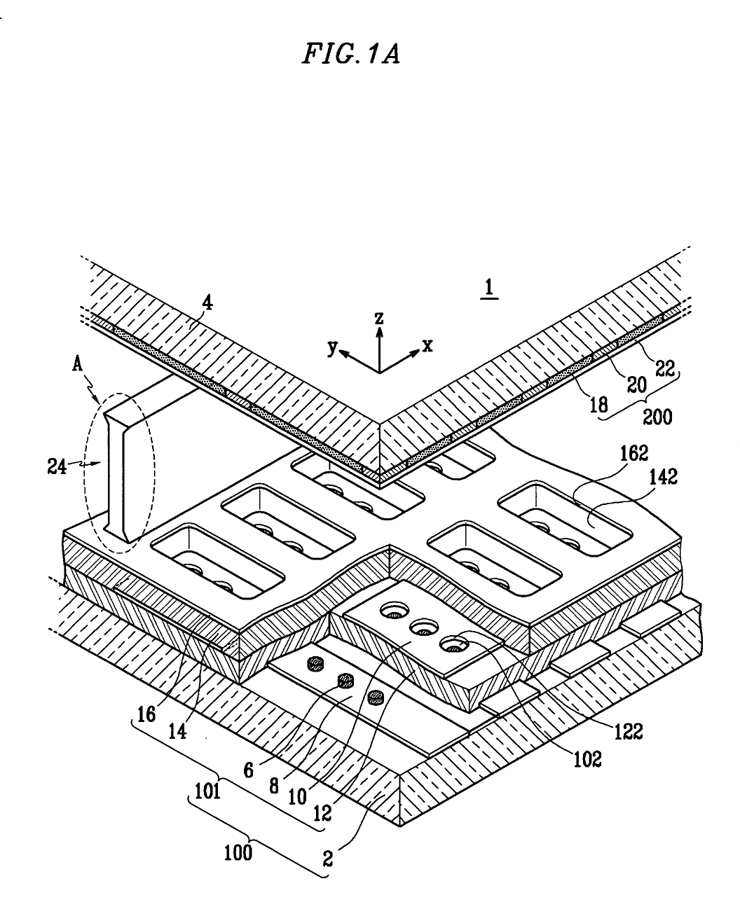

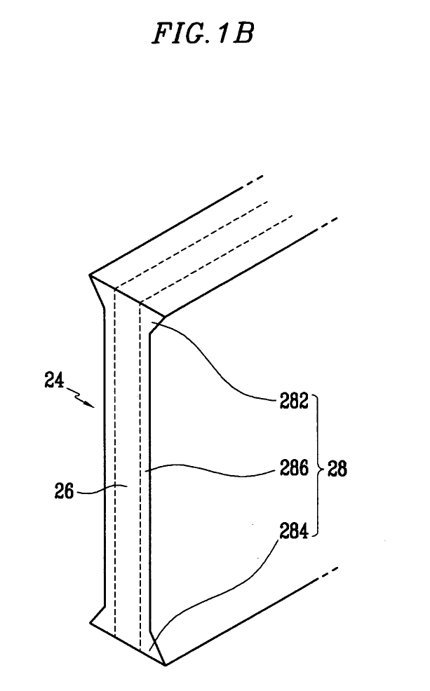

FIGS. 1A thru 3 shows an electron emission display according to a first embodiment of the present invention.

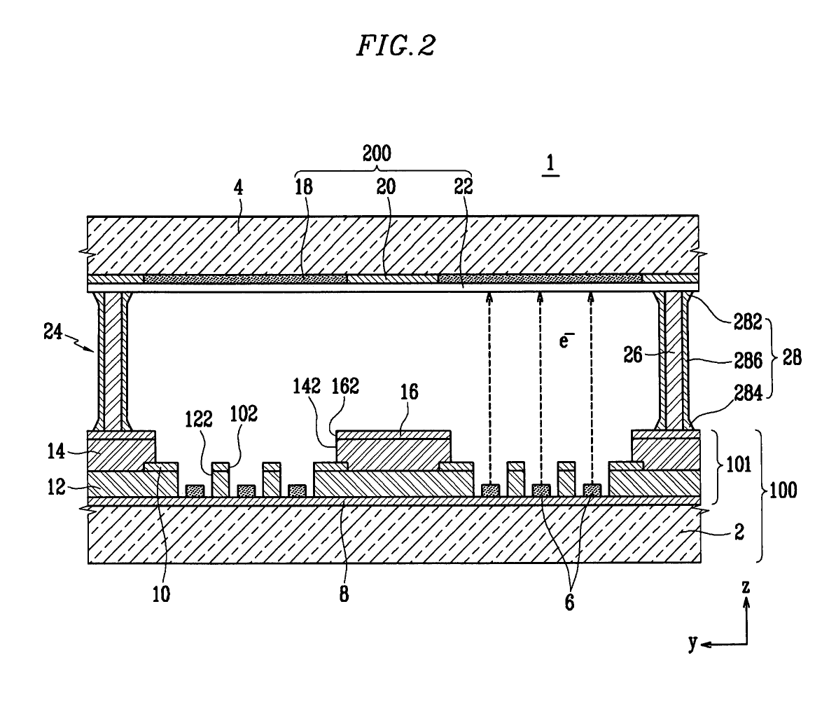

Referring first to FIGS. 1A, 1B and 2, an electron emission display 1 according to the first embodiment of the present invention includes first and second substrates 2 and 4, respectively, facing each other at a predetermined interval. A sealing member (not shown) is provided at the peripheries of the first and second substrates 2 and 4, respectively, so as to seal them together. The space defined by the first and second substrates 2 and 4, respectively, and the sealing member is exhausted to form a vacuum envelope kept to a degree of vacuum of about 10⁻⁶ torr.

The electron emission unit 101 includes electron emission regions 6 formed on the first substrate 2 and driving electrodes, such as cathode and gate electrodes 8 and 10, respectively, for controlling the electron emission of the electron emission regions 6.

In this embodiment, the cathode electrodes 8 are formed in a stripe pattern extending in a direction (along a Y-axis in FIG. 1), and a first insulation layer 12 is formed on the first substrate 2 so as to fully cover the cathode electrodes 8. Gate electrodes 10 are formed on the first insulation layer in a stripe pattern running in a direction (along the X-axis in FIG. 1) so as to cross the cathode electrodes 8 at right angles.

One or more electron emission regions 6 are formed each at a crossed area of the cathode electrodes 8 and the gate electrodes 10. Openings 122 and 102 corresponding to the electron emission regions 6 are formed through the first insulation layer 12 and the gate electrodes 10 to expose the electron emission regions 6.

In this embodiment, a case wherein the electron emission regions 6 are formed in a circular shape and arranged in series along lengths of the cathode electrodes is exemplified, but the present invention is not limited to this case.

The electron emission regions 6 are formed of a material, such as a carbonaceous material or a nanometer-sized material, which emits electrons when an electric field is applied thereto under a vacuum atmosphere. For example, the electron emission regions 6 can be formed of carbon nanotubes, graphite, graphite nanofibers, diamonds, diamond-like carbon, C₆₀, silicon nanowires, or a combination thereof.

Meanwhile, in this embodiment, an example wherein the gate electrode 10 is disposed above the cathode electrodes with the first insulation layer 12 interposed therebetween is presented. However, the present invention is not limited to this case. That is, the cathode electrodes 8 may be disposed above the gate electrodes 10. In this case, the electron emission regions may be formed on the first insulation layer while contacting a surface of the cathode electrodes 8.

A second insulation layer 14 is formed on the first insulation layer 12 to cover the gate electrodes 10, and the focusing electrode 16 is formed on the second insulation layer 14.

Openings 142 and 162 are formed through the focusing electrode 16 and the second insulation layer 14 so as to expose the electron emission regions 6. The openings 142 and 162 are formed in accordance with one per crossed area (hereinafter, referred as “unit pixel area”) of the cathode and gate electrodes 6 and 10, respectively. The focusing electrode 16 may be formed on an entire surface of the first substrate 2 above the second insulation, or may be formed in a predetermined pattern having a plurality of sections.

The electron emission element is comprised of portions of the first and second insulation layers 12 and 14, respectively, focusing electrode 16, and at least one electron emission regions 6 at each unit pixel area.

Describing the light emission unit in more detail, phosphor layers 18 and a black layer 20 for enhancing the contrast of the image are formed on a surface of the second substrate 4 facing the first substrate 2. An anode electrode 22, which is a metal layer formed of, for example, aluminum, is formed on the phosphor and black layers 18 and 20, respectively.

The anode electrode 22 functions to heighten the screen luminance by receiving a high voltage required for accelerating the electron beams and reflecting the visible light rays, radiated from the phosphor layers 18 to the first substrate 2, toward the second substrate 4. The anode electrode 22 is disposed at the effective area of the second substrate 4.

The anode electrode may be a transparent conductive layer formed of, for example, indium tin oxide (ITO) other than the metal layer. In this case, the anode electrode is formed on surfaces of the phosphor and black layers 18 and 20, respectively, which face the second substrate 4. Alternatively, the anode electrode may include both of the metal and transparent conductive layers.

Disposed between the first and second substrates 2 and 4, respectively, are spacers 24 for uniformly maintaining a gap between the first and second substrates 2 and 4, respectively, against an outer force. The spacers 24 are disposed at a portion of the black layer 20 so as not to trespass the phosphor layers 18.

In this exemplary embodiment, the spacer 24 includes a main body 26 and a coating layer 28 formed on a side surface of the main body and having a variable thickness.

The main body 26 of the spacer 24 maybe formed of ceramic or glass in a rectangular or circular cylinder-type or a wall-type.

As shown in FIG.1B and FIG.2, the coating layer 28 includes an upper coating layer 282 contacting the anode electrode 22, a lower coating layer 284 contacting the focusing electrode 16, and a central coating layer 286 integrally connecting the upper coating layer 282 to the lower coating layer 284.

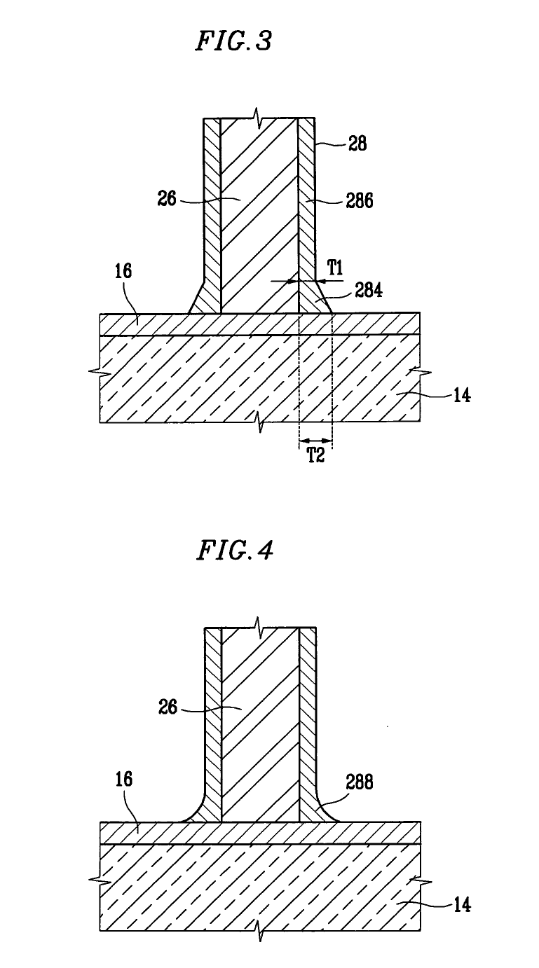

As shown in FIG. 3, the lower coating layer 284 has a thickness which gradually increases from a connecting portion with the central coating layer 286 to a lower end of the main body 26, i.e., to a contacting portion with the focusing electrode 16. That is, the thickness of the lower coating layer is greater than the central coating layer 286. Therefore, a contacting area of the lower coating portion 284 with the focusing electrode 16 increases so as to reduce the contact resistance of the coating layer 28.

Likewise, the upper coating layer 282 has a thickness which gradually increase from a connecting portion with the central coating layer 286 to an upper end of the main body 26, i.e., to a contacting portion with the anode electrode 22.

The maximum thickness T₂ of the lower coating layer 284 may be up to five times the thickness T₁ of the central coating layer 286 (T₂/T₁<5). When the maximum thickness T₂ of the lower coating layer 284 is greater than five times the thickness T₁ of the central coating layer 286, there may be difficulties in the manufacturing process, and the lower coating layer 284 may be broken when the spacer is loaded in the vacuum envelope.

The thickness increase rate of the lower coating layer 284 may be constant. That is, the thickness of the lower coating layer 284 increases such that a sectional shape of the coating layer 284 varies linearly.

As described above, the coating layer 28 is formed on the side surfaces of the main body 26 and contacts the anode and focusing electrodes 22 and 16, respectively, thereby allowing a micro current to flow between the anode and focusing electrodes 22 and 16, respectively, through the coating layer 28. At this point, since the upper and lower coating layers 282 and 284, respectively, increase in thickness toward the focusing and anode electrodes 16 and 22, respectively, the resistance of the coating layer 282 is reduced, and thus the current flow through the coating layer 284 can be effectively realized.

The coating layer 284 may be formed of chromium oxide (Cr₂O₃), titanium nitride (TiN), zirconium oxide (ZrO₂), diamond-like carbon, or a combination thereof.

The coating layer 283 may be formed through electron beam deposition, sputtering, or plating process. At this point, a mask may be used to form the coating layer having the variable thickness.

FIG. 4 shows a spacer, focusing electrode and second insulation layer of an electron emission display according to a second embodiment of the present invention. In this embodiment, the thickness increase rate of the lower coating layer 288 increases downward such that a sectional shape of the lower coating layer 288 is curved.

In the foregoing embodiments, a case where a thickness of the main body 26 is uniform while the lower coating layers 284 and 288 vary in the thickness is exampled. However, the present invention is not limited to this case. That is, the lower coating layer may have a thickness that is variable by varying the thickness of the main body.

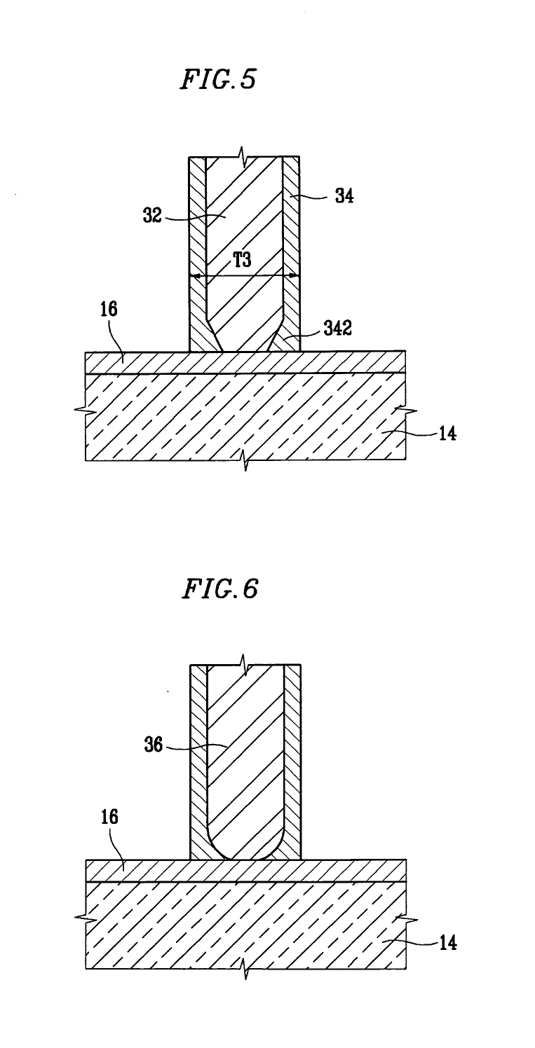

FIG. 5 shows a spacer, focusing electrode and second insulation layer of an electron emission display according to a third embodiment of the present invention and FIG. 6 is an enlarged sectional view of a spacer, focusing electrode and second insulation layer of an electron emission display according to a fourth embodiment of the present invention.

Referring to FIG. 5, a spacer 30 has a main body 32 having a lower portion, the thickness of which is gradually reduced downward, and a coating layer 34 formed on a side surface of the main body 32 to make the overall thickness of the space uniform. Therefore, a lower coating layer 342 has a thickness which increases downward by as much as the thickness reduction rate of the main body 32. The thickness reduction rate of the lower portion of the main body 32 is constant.

Referring to FIG. 6, a lower portion of a main body 36 may have a thickness which is gradually reduced downward at the thickness reduction rate increasing gradually. Therefore, the sectional shape of the lower portion of the main body 36 may be curved.

The structure, material, shape, and thickness variation rate applied to the lower coating layer may be identically applied to the upper coating layer.

Although the electron emission display having the FEA elements is exemplified in the above embodiments, the present invention is not limited to this example. That is, the present invention may be applied to an electron emission display having other types of electron emission elements such as SCE elements, MIM elements or MIS elements.

According to the present invention, since the spacer has a variable coating layer, the contact area between the coating layer and the focusing and/or between the coating layer and the anode layer can increase, thereby minimizing the contact error with the electrodes. As a result, the electric conduction efficiency of the spacer is improved, thereby effectively discharging secondary electrons to an external side through the coating layer.

Although exemplary embodiments of the present invention have been described in detail hereinabove, it should be clearly understood that many variations and/or modifications of the basic inventive concept taught herein still fall within the spirit and scope of the present invention, as defined by the appended claims.

What is claimed is:

1. A spacer, comprising:
a main body disposed between first and second substrates which have first and second electrode layers, respectively; and
a coating layer formed on a side surface of the main body;
wherein the coating layer has a first portion contacting one of the first and second electrode layers and a second portion formed on a central portion of the side surface of the main body, a thickness of the first portion being greater than a thickness of the second portion.

2. The spacer of claim 1, wherein the coating layer includes an upper coating layer contacting the second electrode layer, a lower coating layer contacting the first electrode layer, and a central layer integrally connecting the upper coating layer to the lower coating layer; and
wherein a thickness of at least one of the upper and lower coating layers increases gradually from a connecting portion with the central coating layer to an end of the main body.

3. An electron emission display, comprising:
first and second substrates facing each other to form a vacuum envelope;
an electron emission unit provided on the first substrate;
a light emission unit provided on the second substrate; and
a spacer disposed between the electron emission unit and the light emission unit,
wherein the spacer comprises:
a main body disposed between first and second substrates that have first and second electrode layers, respectively; and
a coating layer formed on a side surface of the main body;
wherein the coating layer has a first portion contacting one of the electron and light emission units, and a second portion formed on a central portion of the side surface of the main body, a thickness of the first portion being greater than a thickness of the second portion.

4. The electron emission display of claim 3, wherein the coating layer includes an upper coating layer contacting the light emission unit, a lower coating layer contacting the electron emission unit, and a central layer integrally connecting the upper coating layer to the lower coating layer; and
wherein a thickness of at least one of the upper and lower coating layers increases gradually from a connecting portion with the central coating layer to an end of the main body.

5. The electron emission display of claim 4, wherein a thickness of the main body is uniform; and
wherein at least one thickness of the upper and lower coating layers varies.

6. The electron emission display of claim 5, wherein a thickness increase rate of at least one of the upper and lower coating layers is constant.

7. The electron emission display of claim 5, wherein a thickness increase rate of at least one of the upper and lower coating layers increases.

8. The electron emission display of claim 4, wherein the main body has a first portion corresponding to at least one of the upper and lower coating layers; and
wherein a thickness of the first portion of the main body is gradually reduced toward an end thereof.

9. The electron emission display of claim 8, wherein a thickness of the spacer is uniform.

10. The electron emission display of claim 8, wherein a thickness reduction rate of the first portion of the main body is constant.

11. The electron emission display of claim 8, wherein a thickness reduction rate of the first portion of the main body increases.

12. The electron emission display of claim 4, wherein the upper coating layer, the lower coating layer, and the central coating layer satisfy the following condition:
T₂/T₁<5
where, T₁ is a thickness of the central coating layer and T₂ is a maximum thickness of one of the upper and lower coating layers.

13. The electron emission display of claim 4, wherein the coating layer includes a material selected from a group consisting of chromium oxide (Cr₂O₃), titanium nitride (TiN), zirconium oxide (ZrO₂), diamond-like carbon, and a combination thereof.

14. The electron emission display of claim 3, wherein the electron emission unit comprises:
cathode and gate electrodes formed on the first substrate and insulated from each other;
an electron emission region connected to the cathode electrode; and
a focusing electrode formed on, and insulated from, the cathode and gate electrodes.

15. The electron emission display of claim 14, wherein the spacer is disposed on the focusing electrode.

16. The electron emission display of claim 14, wherein the electron emission region includes a material selected from a group consisting of carbon nanotubes, graphite, graphite nanofibers, diamonds, diamond-like carbon, C₆₀, silicon nanowires, or a combination thereof.
